(19) United States
(12) Patent Application Publication
(10) Pub. No.: US 2007/0113717 A1
(43) Pub. Date: May 24, 2007

(54) Cutting fixture for printed circuit board mounted with electronic components

(75) Inventors: Yan-Jun Feng, Taipei (TW); Qingbao Niu, Taipei (TW); Chiy-Ray Shiue, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/393,124

(22) Filed: Mar. 29, 2006

(30) Foreign Application Priority Data
Nov. 24, 2005 (TW) 094220347

(51) Int. Cl. B26D 7/02

(52) U.S. Cl. 83/451; 83/929.1

(57) ABSTRACT

A cutting fixture for a printed circuit board mounted with electronic components is proposed. The cutting fixture includes a base and a replaceable cover plate mounted on the base. The cover plate has openings for receiving the electronic components of the printed circuit board, cutting through holes for allowing a cutting tool to pass through, guide blocks for engaging lateral sides of the printed circuit board, and positioning posts for fixing the printed circuit board to the cover plate. Thus, a printed circuit board mounted with electronic components can be quickly and accurately fixed to the cutting fixture, thereby improving the cutting efficiency and cutting quality.

### BACKGROUND OF THE INVENTION

1. Field of the Invention

The present invention relates to a cutting fixture for printed circuit boards, and more particularly to a cutting fixture for printed circuit boards mounted with electronic components.

2. Description of Related Art

With rapid development of the science and technology, along with rapidly increasing demands for electronic products with multiple functions, modular designs and modular fabrication processes for printed circuit boards have become a mainstream on account of factors such as the economic efficiency and the production cost.

In a conventional modular fabrication process for printed circuit boards, a plurality of printed circuit board units is first defined on a whole piece of printed circuit board module. Then, a plurality of circuit structures is formed on the whole piece of printed circuit board module corresponding to the printed circuit board units such that electronic components such as semiconductor chips or other active and passive components can be mounted to the printed circuit board units. Finally, the whole piece of printed circuit board module is fixed to a cutting fixture and a cutting tool is used to cut the whole piece between the printed circuit board units. Thus, the whole piece of printed circuit board module is cut into a plurality of printed circuit boards mounted with electronic components.

FIG. 1 is a conventional cutting fixture for a printed circuit board. As shown in FIG. 1, the cutting fixture has a grid-shaped plate 11 formed thereon. A plurality of positioning holes 110 is formed in the grid-shaped plate 11. The positioning holes 110 correspond in position to openings formed on the surface of a printed circuit board module to be cut. A plurality of positioning pins 12 are inserted into and fixed to the positioning holes 110. The printed circuit board module to be cut can then be fixed to the positioning pins 12 through the openings of the printed circuit board module.

Although the above positioning pins can be inserted into different positioning holes according to different types of printed circuit board modules, it may take as much as 2 hours to rearrange the positioning pins to make them correspond in position to a new type of printed circuit board modules in practical fabrication processes, thereby adversely affecting the cutting efficiency. In addition, since the distance between the adjacent positioning holes arranged on the grid-shaped plate is certain and can not be changed, it is almost impossible to completely align the positioning pins with the predefined openings of the printed circuit board module, which not only makes it difficult to fix the printed circuit board module to the cutting fixture, but also leads to too loose or too tight engagement between the positioning pins and the openings. Too loose engagement between the positioning pins and the openings causes the printed circuit board module to displace during the cutting process, while too tight engagement between the positioning pins and the openings increases difficulty of detachment of the printed circuit board module from the cutting fixture and causes the printed circuit board module to tilt during the cutting process. Displacing and tilting of the printed circuit board module are easy to introduce the cutting error during the cutting process, which adversely affects the cutting quality.

### SUMMARY OF THE INVENTION

According to the above defects, an objective of the present invention is to provide a cutting fixture for a printed circuit board mounted with electronic components, which can effectively fix the printed circuit board to the cutting fixture so as to prevent the displacement of the cutting position of the printed circuit board.

Another objective of the present invention is to provide a cutting fixture for a printed circuit board mounted with electronic components, through which a printed circuit board mounted with electronic components can be easily attached to or detached from the cutting fixture, thereby increasing the cutting efficiency.

A further objective of the present invention is to provide a cutting fixture for a printed circuit board mounted with electronic components, which can efficiently prevent cutting errors, thereby increasing the production yield.

To achieve the above and other objectives, the present invention discloses a cutting fixture for a printed circuit board mounted with electronic components. The cutting fixture comprises: a base; and a replaceable cover plate mounted on the base, wherein, the cover plate comprises openings for receiving the electronic components of the printed circuit board, cutting through holes for allowing a cutting tool to pass through, guide blocks for engaging lateral sides of the printed circuit board, and positioning posts for fixing the printed circuit board to the cover plate.

The cover plate can be secured to the base by screws and changed to adapt the cutting fixture to different types of printed circuit boards.

The openings of the cover plate can respectively receive the electronic components disposed on and extending away from the surface of the printed circuit board. Meanwhile, the size of the openings can be changed according to that of the corresponding electronic components.

The cutting through holes of the cover plate allow the cutting tool to be inserted therein such that the cutting tool can cut the printed circuit board along a predefined cutting line.

The guide blocks of the cover plate are disposed on lateral sides of the cover plate so as to abut against the printed circuit board. Oblique surfaces can be respectively formed on inner sides of the guide blocks engaging the printed circuit board such that the printed circuit board can be slid to position. The guide blocks further can fix the leftover materials from the cutting process.

The positioning posts are mounted on the cover plate corresponding in position to openings predefined in the printed circuit board so as to fix the printed circuit board to the cover plate.

Therefore, through the guide blocks and the positioning posts of the cover plate, a printed circuit board can be quickly and accurately mounted to the cutting fixture and securely and steadily hold by the cutting fixture with the electronic components of the printed circuit board being received in the corresponding openings of the cover plate. The displacing and tilting of the printed circuit board are prevented, the mounting time is reduced, and the cutting efficiency and cutting quality are increased. In addition, since the leftover material is fixed to the cutting fixture, cutting accidents are prevented.

Furthermore, in the present invention, to cut a different type of printed circuit board, only the cover plate of the cutting fixture needs to be replaced, thereby saving the cutting fixture assembly time.

### BRIEF DESCRIPTION OF DRAWINGS

FIG. 1 is a diagram of a conventional printed circuit board cutting fixture; and

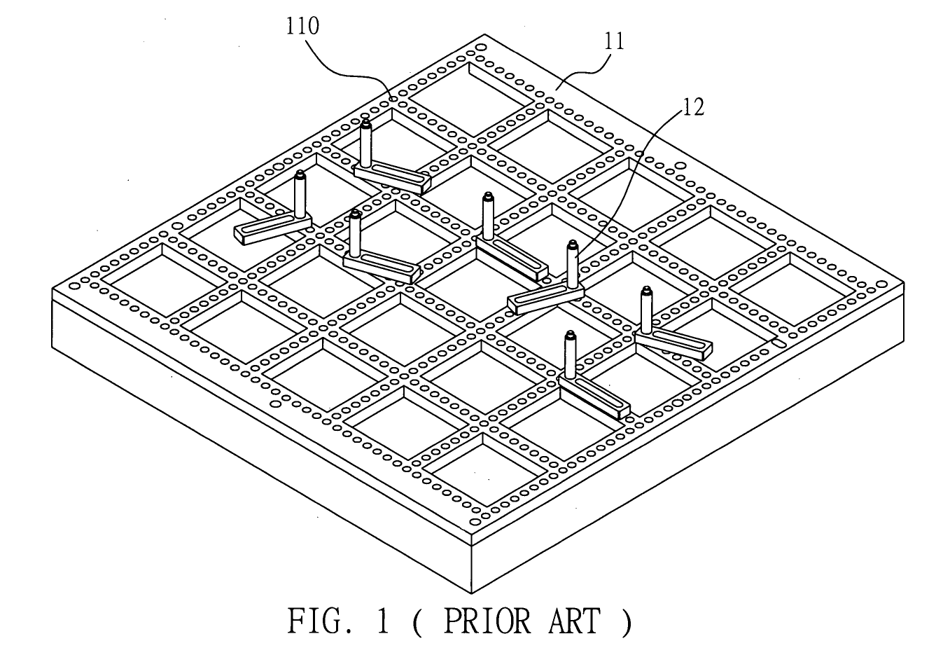

FIG. 2 is a diagram of a cutting fixture for a printed circuit board mounted with electronic components according to the present invention.

### DETAILED DESCRIPTION OF PREFERRED EMBODIMENTS

Hereunder, embodiments of the present invention will be described in full detail with reference to the accompanying drawings.

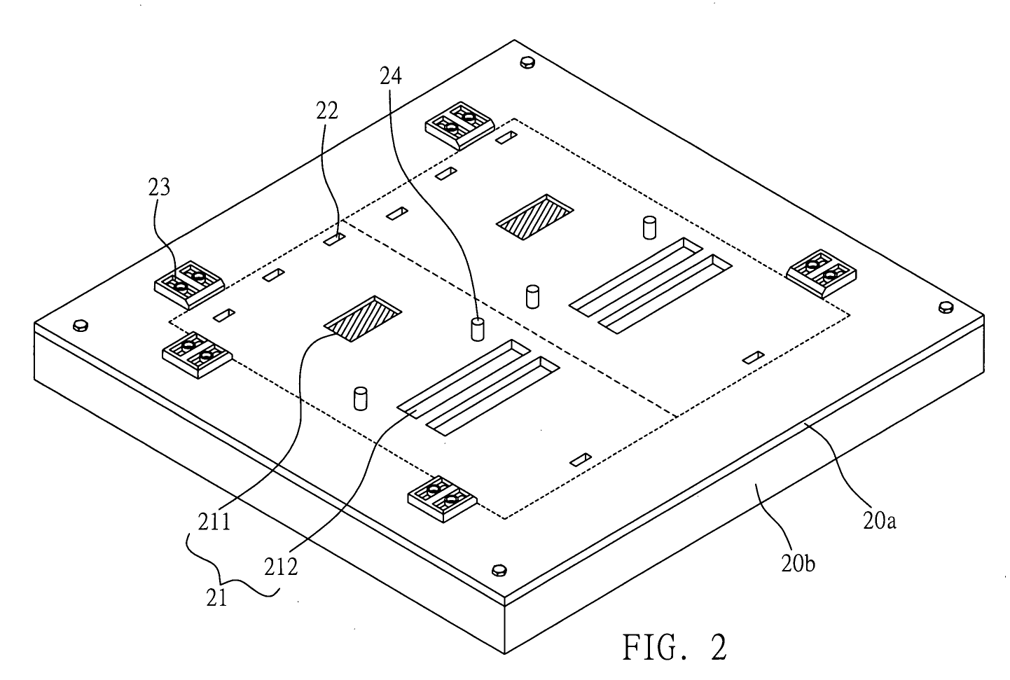

Referring to FIG. 2, a cutting fixture used to hold a printed circuit board mounted with electronic components during a cutting process is shown.

As seen in FIG. 2, the cutting fixture comprises a base 20b and a replaceable cover plate 20a mounted on the base 20b. The base 20b and the cover plate 20a jointly define a receiving space therebetween. The cover plate 20a comprises a plurality of openings 21 for receiving the electronic components of the printed circuit board, a plurality of cutting through holes 22 for allowing a cutting tool to pass through, a plurality of guide blocks 23 for engaging lateral sides of the printed circuit board, and positioning posts 24 for fixing the printed circuit board to the cover plate 20a.

The cover plate 20a is detachably secured to the base 20b by screws or latching components such that the cover plate 20a can be easily replaced according to different types of printed circuit boards. That is, to cut a different type of printed circuit board, a user only needs to mount a corresponding cover plate 20a on the base 20b, which increases the assembly speed of the cutting fixture and accordingly increases the cutting efficiency and cutting quality.

The openings 21 of the cover plate 20a can receive electronic components disposed on and extending away from the surface of the printed circuit board. The electronic components can be different types of active and passive components such as semiconductor chips, conductor components, resistor components and inductor components. Meanwhile, size of the openings 21 can be changed according to that of the electronic components. The openings 21 can further be divided into openings 211 penetrating through the cover plate 20a and openings 212 without penetrating through the cover plate 20a.

The cutting through holes 22 of the cover plate 20a allow a cutting tool such as a milling cutter to be inserted therein such that the cutting tool can cut the printed circuit board along a predefined cutting line so as to form a plurality of printed circuit board units.

The guide blocks 23 are disposed on lateral sides of the cover plate 20a and abut against the printed circuit board mounted to the cover plate 20a to prevent the displacement of the printed circuit board. Meanwhile, oblique surfaces can be respectively formed on inner sides of the guide blocks 23 that engage the printed circuit board such that the printed circuit board can be slid along the oblique surfaces into position. Further, the leftover materials from the cutting process can be fixed to the guide blocks 23 to avoid cutting accidents.

The positioning posts 24 are disposed on the cover plate 20a corresponding in position to openings predefined in the printed circuit board such that the printed circuit board can be fixed to the cover plate 20a through the positioning posts 24.

Therefore, the cutting fixture of the present invention mainly comprises a base and a cover plate. The cover plate has a plurality of openings formed therein to receive electronic components mounted on a printed circuit board, a plurality of cutting through holes formed therein to allow a cutting tool to pass through, a plurality of guide blocks disposed thereon to engage lateral sides of the printed circuit board and a plurality of positioning posts disposed thereon to fix the printed circuit board to the cover plate. With the help of the guide blocks and the positioning posts, a printed circuit board can be quickly, accurately and steadily fixed to the cover plate with its electronic components received in the corresponding openings of the cover plate, thereby preventing the printed circuit board from displacing and tilting. As a result, the cutting efficiency and cutting quality are increased, while the assembly time and labor cost are reduced. In addition, since the leftover material is fixed to the cutting fixture, cutting accidents are prevented.

Furthermore, the cutting fixture of the present can be adapted to different types of printed circuit boards by changing the cover plate. To cut a different type of printed circuit board, only the cover plate of a cutting fixture needs to be replaced. Hence, the fixture assembly time is reduced and the cutting efficiency and cutting quality are increased.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A cutting fixture for a printed circuit board mounted with electronic components, comprising:
a base; and
a replaceable cover plate mounted on the base, wherein, the cover plate comprises openings for receiving the electronic components of the printed circuit board, cutting through holes for allowing a cutting tool to pass through, guide blocks for engaging lateral sides of the printed circuit board, and positioning posts for fixing the printed circuit board to the cover plate such that the printed circuit board can be quickly and accurately fixed to the cutting fixture, thereby improving the cutting quality.

2. The cutting fixture of claim 1, wherein the cover plate is secured to the base by screws.

3. The cutting fixture of claim 1, wherein the cutting fixture can be adapted to different types of printed circuit boards by changing the cover plate.

4. The cutting fixture of claim 1, wherein the openings of the cover plate respectively receive the electronic components disposed on and extending away from the surface of the printed circuit board, and size of the openings can be changed according to that of the corresponding electronic components.

5. The cutting fixture of claim 1, wherein each of the openings is one of an opening penetrating the cover plate and an opening without penetrating the cover plate.

6. The cutting fixture of claim 1, wherein the cutting through holes allow the cutting tool to be inserted therein such that the cutting tool can cut the printed circuit board along a predefined cutting line. [symbol] the cover plate so as to abut against the printed circuit board.

8. The cutting fixture of claim 1, wherein oblique surfaces are respectively formed on inner sides of the guide blocks engaging the printed circuit board.

9. The cutting fixture of claim 1, wherein the guide blocks fix the leftover materials from the cutting process.

10. The cutting fixture of claim 1, wherein the positioning posts are mounted on the cover plate corresponding in position to openings predefined in the printed circuit board so as to fix the printed circuit board to the cover plate.
